(19) United States
(12) Patent Application Publication
(10) Pub. No.: US 2014/0305151 A1
(43) Pub. Date: Oct. 16, 2014

(54) BEVERAGE DISPENSER

(71) Applicant: NOTTINGHAM SPIRK DESIGN ASSOCIATES, INC., (US)

(72) Inventors: John W. Nottingham, Westlake, OH (US); Nick E. Stanca, Westlake, OH (US); James Edward Szpak, Cleveland Heights, OH (US)

(73) Assignee: NOTTINGHAM SPIRK DESIGN ASSOCIATES, INC., Cleveland, OH (US)

(21) Appl. No.: 13/863,819

(22) Filed: Apr. 16, 2013

(51) Int. Cl. B67D 3/00

(52) U.S. Cl. CPC B67D 3/0009
USPC 62/126; 62/394; 62/228.1; 62/389; 62/129

(57) ABSTRACT

A compact beverage dispensing unit includes a cooling system and a housing. A dispensing channel is defined in the housing. The dispensing channel is configured to allow associated beverage containers located in the dispensing channel to move via gravity toward a dispensing outlet of the housing

### BACKGROUND

Refrigerated beverage containers, such as cans and bottles, are typically stored in large refrigerators. This is true at retail locations as well as at home or in office locations. It would be desirable to store refrigerated beverage containers in smaller units that are easily affordable and/or that occupy less space than large refrigerators. Ideal temperature for beverage consumption or a consumer's preferred temperature may be different, e.g., lower, than a standard home refrigerator setting.

### SUMMARY

An example of a beverage dispensing unit for dispensing associated beverage containers, each containing a carbonated non-alcoholic beverage, includes a housing, a cooling system in the housing, a user input device on the housing, and a controller. The housing includes a beverage container inlet, a dispensing outlet, and at least one beverage container dispensing channel defined in the housing between the beverage container inlet and the dispensing outlet. The cooling system is for cooling the associated beverage containers disposed along the beverage container dispensing channel. The input device is for receiving user input to control the cooling system. The controller is in communication with the user input device and the cooling system. The controller is configured to operate the cooling system to maintain the beverage container dispensing channel within at least one of a first temperature range and a second temperature range, based on input received from the user input device. The second temperature range is lower than the first temperature range and the second temperature range is below the freezing point of water and above a freezing point of a carbonated non-alcoholic beverage in an unopened container.

Another example of a beverage dispensing unit includes a housing, a compressor, a condenser plate and an evaporator plate. The housing includes a beverage compartment and a cooling system components compartment. The compressor is disposed in the cooling system components compartment. The condenser plate is in fluid communication with the compressor. The evaporator plate is in fluid communication with the compressor and positioned along a lowermost surface of the beverage compartment such that beverage containers positioned within the beverage compartment contact the evaporator plate.

### BRIEF DESCRIPTION OF THE DRAWINGS

FIG. 1 is a perspective view of another example of a beverage dispensing unit.

FIG. 2 is a perspective view of the beverage dispensing unit of FIG. 1 with an inlet door in an open position.

FIG. 3 is a longitudinal cross—sectional view of the beverage dispensing unit of FIG. 1.

FIG. 4 is a perspective view of the beverage dispensing unit of FIG. 1 with the inlet door and an access door both in an open position.

FIG. 5 is front view of the beverage dispensing unit of FIG. 1 with a display panel and a lens removed.

FIG. 6 is a transverse cross—sectional view of the beverage dispensing unit of FIG. 1.

### DETAILED DESCRIPTION

The description and drawings herein are merely illustrative and various modifications and changes can be made to the structures disclosed herein without departing from the scope of the appended claims. Identified components of a beverage dispensing unit described below are merely terms of art that may vary from one manufacturer to another and should not be deemed to limit the present disclosure or the appended claims.

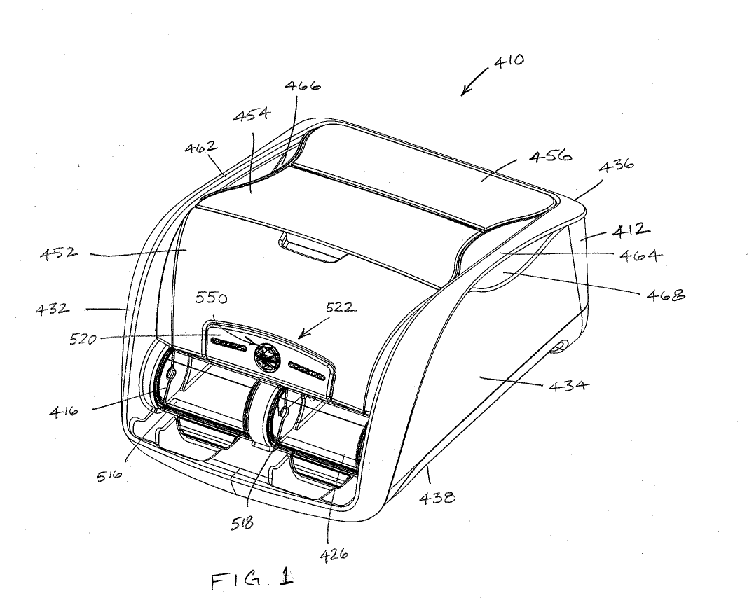

FIG. 1 depicts an embodiment of a beverage dispensing unit 410 for dispensing associated beverage containers (not shown) each containing a carbonated non-alcoholic beverage. For example, the beverage dispensing unit 410 could be used to dispense conventional 12-ounce beverage cans. The dispensing unit 410 could also be designed to dispense containers of a different size.

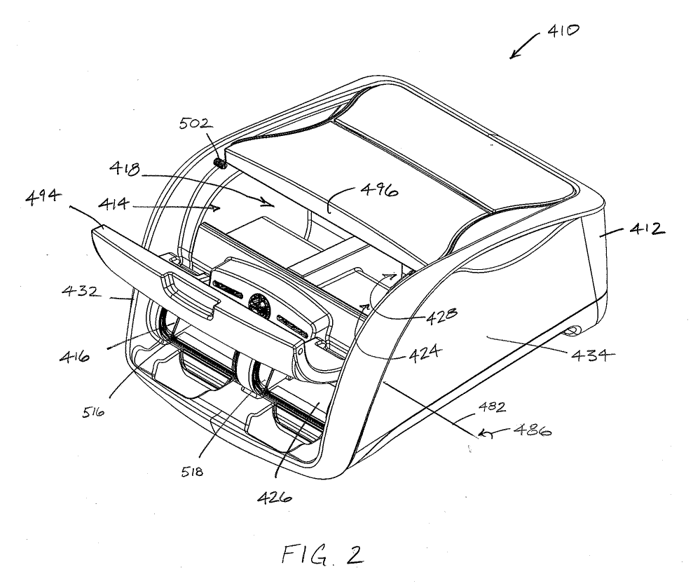

With reference to FIG. 2, the beverage dispensing unit 410 includes a housing 412 including a beverage container inlet 414, a dispensing outlet 416, and a beverage container dispensing channel 418 defined in the housing 412 between the beverage container inlet 414 and the dispensing outlet 416. In the illustrated embodiment, the housing 412 includes a second beverage container inlet 424, a second dispensing outlet 426, and a second beverage container dispensing channel 428 defined in the housing between the second beverage container inlet 424 and the dispensing outlet 426. Each beverage container dispensing channel 418, 428 is configured to hold six conventional 12-ounce (355 milliliter) beverage cans.

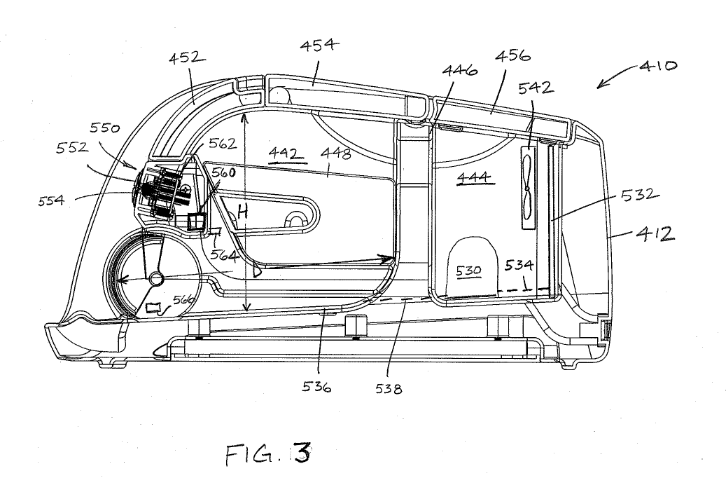

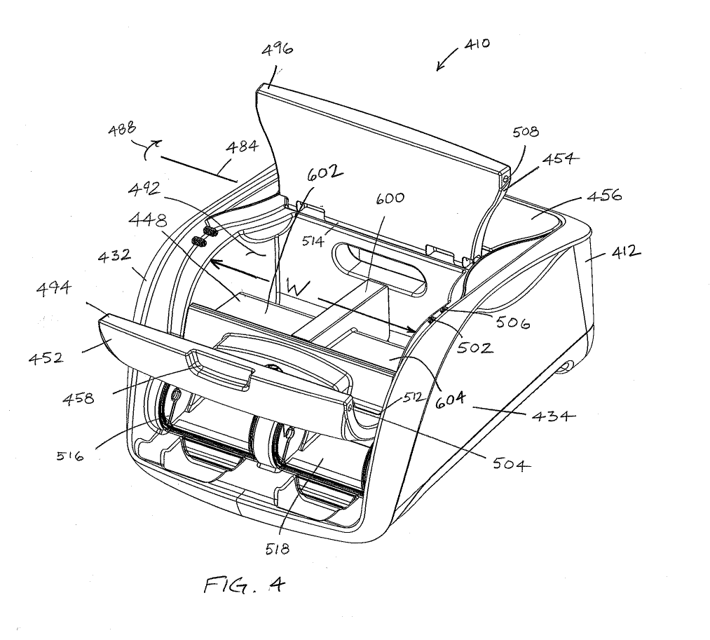

With reference back to FIG. 1, the housing 412 includes a left side 432, a right side 434, a rear side 436, and a bottom 438. With reference to FIG. 3, the housing 412 defines a beverage compartment 442 and a cooling system components compartment 444. The beverage compartment 442 is separated from the cooling system components compartment 444 by a transverse dividing wall 446. Both of the beverage container dispensing channels 418 and 428 are located within the beverage compartment 442. For the beverage dispensing unit 410, illustrated in FIGS. 1-6, the beverage compartment 442 has a volume sufficient to receive twelve 12-ounce beverage cans and a housing track member 448 (see also FIG. 4) that defines a portion of each beverage container dispensing channel 418, 428. The beverage compartment 442 is typically much smaller than a conventional refrigerator found in a typical US household. For example, the beverage compartment 442, and thus each beverage container dispensing channel 418, 428, has a maximum height H that is less than three times a maximum diameter (e.g., about 2.5 inches) of one conventional 12-ounce beverage can. Similarly, the beverage compartment 442 and each beverage container dispensing channel 418, 428 has a maximum depth D less than 3.5 times the maximum diameter of one conventional 12-ounce beverage can. Also, the beverage compartment 442 has a maximum width W (FIG. 4) less than 2.5 times the height (e.g., about 4.75 inches) of a conventional 12-ounce beverage can. As such, the beverage compartment 442 is very compact, which allows for quick chilling of the beverage containers within the beverage compartment, and there is not a lot of excess space within the beverage compartment, which can result in a more efficient beverage dispensing unit 410.

With reference to FIG. 4, an inlet door 452, an access door 454 and a rear cover 456 each attach to the housing 412. When closed, the inlet door 452 and the access door 454 cover the beverage compartment 442. The rear cover 456 covers the cooling system components compartment 444. A recess 458 formed in the inlet door 452 operates as a handle for the inlet door. Handles 462 and 464 (most clearly seen in FIG. 1) are provided on opposite sides of the housing 412. As illustrated, each side 432, 434 of the housing 412 includes a corresponding recess 466, 468, which spaces the respective handle 462, 464 from an adjacent external surface of the housing 412. This allows the handles 462, 464 to remain substantially flush with the top of the access door 454 and the rear cover 456 when each are in a closed position. As such, the handles 462, 464 do not add to the overall height of the beverage dispensing unit 410.

With reference to FIG. 2, the inlet door 452 pivots about an inlet door pivot axis 482. As seen in FIG. 4, the access door 454 pivots about an access door pivot axis 484, which is substantially parallel to the inlet door pivot axis 482. The inlet door 452 pivots in a first rotational direction 486 (see arrow in FIG. 2) from a closed position (shown in FIG. 1) toward an open position (shown in FIG. 2). The access door 454 pivots in a second rotational direction 488 (see FIG. 4), which is opposite to the first rotational direction 486, from a closed position (shown in FIG. 1) toward an open position (shown in FIG. 4) about the access pivot door axis 484. Movement of the inlet door 452 away from the access door 454 provides a large opening 492 when the inlet door 452 and the access door 454 are each in the open position (shown in FIG. 4). The housing track member 448, which defines a portion of each of the beverage container dispensing channels 418, 428, is removable from the housing 412 without the use of tools when the inlet door 452 and the access door 454 are each in the open position. This allows for removal of the housing track member 448 from the housing 412 to allow for cleaning of the beverage compartment 442.

Both the inlet door 452 and the access door 454 substantially span the width of the housing 412. As such, both the first beverage container dispensing channel 418 and the second beverage container dispensing channel 428 are accessible when at least one of the inlet door 452 and the access door 454 are in the open position. The inlet door 452 connects with the housing 412 and selectively covers each beverage container inlet 414, 424. The access door 454 connects with the housing 412 and selectively covers an area of each beverage container dispensing channel 418, 428 downstream from each beverage container inlet 414, 424. A free end 494 of the inlet door 452 contacts a free end 496 of the access door 454 when the inlet door 452 and the access door 454 are each in the closed position, as shown in FIG. 1. The free ends 494 and 496 can cooperate to form a seal to inhibit the escape of cool air from the beverage compartment 448 to ambient. Inlet door plungers 502 extend inwardly from respective sides 432, 434 of the housing 412 and cooperate with recesses 504 formed adjacent the free end 494 of the inlet door 452. The plungers 502 are spring biased so as to engage inside the recesses 504 to retain the inlet door 452 in the closed position. Similarly, access door plungers 506 can extend inwardly from respective sides 432, 434 of the housing 412 and cooperate with recesses 508 formed adjacent the free end 496 of the access door 454. These plungers 506 can also be spring biased to retain the access door 454 in the closed position.

Each door 452, 454 can include axle posts (not visible) for connecting respective fixed ends 512, 514 of the doors 452, 454 to the housing 412. The doors 452 and 454 can connect with the housing 412 in other conventional manners.

The beverage dispensing unit 410 can also include outlet doors 516 and 518. Each outlet door 516, 518 is disposed adjacent a respective dispensing outlet 416, 426. Each outlet door 516, 518 can be made from a transparent plastic material so that the beverage container 18 disposed adjacent to the dispensing outlet 16 is visible from outside the unit 18. Each outlet door 516, 518 can also be made from a double walled plastic material, i.e., to include an air void between the two walls, which enhances the insulating properties of the outlet door. To open the outlet doors 516, 518 an operator grasps a flange on a respective door and rotates the door upwardly (per the orientation shown in the figures) about a horizontal axis.

A display panel 520 connects with the housing 412 and provides a mounting location for display 522 which will be described in more detail below.

With reference to FIG. 3, the beverage dispensing unit 410 includes a compressor 530 located within the cooling system components compartment 444. The compressor 530 is in fluid communication with a condenser plate 532 via line 534 and an evaporator plate 536 via line 538. The condenser plate 532 defines at least one fluid passage (not depicted) through which refrigerant travels and the evaporator plate 536 also defines at least one fluid passage (not depicted) through which refrigerant travels. The compressor 530, the condenser plate 532 and the evaporator plate 536 can operate in a conventional manner of a refrigeration cycle.

A fan 542 can also be located in the cooling system components compartment 444 to blow across the condenser plate 532 to expel warm air from the cooling system components compartment 444 and thus from the beverage dispensing unit 410. The cooling system, made up of the compressor 530, the condenser plate 532, the evaporator plate 536, and the respective lines 534, 538 are disposed in the housing 412 and are for cooling the beverage containers disposed along the beverage container dispensing channels 418, 428.

The beverage dispensing unit 410 also includes a user input device 550 on the housing 412 for receiving user input to control the cooling system. The user input device 550 in the illustrated embodiment mounts to the display panel 520. The user input device 550 is mounted to the exterior of the housing 412, other than the rear 436 or the bottom 438 of the housing, which makes the user input device 550 easily accessible to an operator of the beverage dispensing unit 410. In the illustrated embodiment, the user input device 550 includes a first button 552 and a second button 554. The operator can press the first button 552 whereby the cooling system operates such that the beverage compartment 442 and thus the beverage container dispensing channels 418, 428 are maintained within a first temperature range. The operator can press the second button 554 whereby the cooling system operates such that the beverage compartment 442 and the beverage container dispensing channels 418, 428 are maintained within a second temperature range.

With reference to FIG. 3, the beverage dispensing unit 410 also includes a controller 560 (depicted schematically) in communication with the user input device 550 and the cooling system. The controller 560 can be in the form of circuitry (not visible) provided on a printed circuit board 562 mounted rearward of the display panel 520. The controller 560 is configured to operate the cooling system to maintain the beverage compartment 442, and thus the beverage container dispensing channels 418, 428, within at least one of the first (higher) temperature range and the second (lower) temperature range.

For example, an operator of the beverage dispensing unit 410 can press the first button 552 to operate the cooling system to cool the beverage compartment 442 in a first temperature range between about 36 degrees and about 42 degrees Fahrenheit. If the operator desires a cooler beverage, the operator can press the second button 554 and the cooling system will draw down the temperature in the beverage compartment 442 to a second temperature range, which is lower than the first temperature range. The second temperature range can be below the freezing point of water and above a freezing point of a carbonated non-alcoholic beverage in an unopened container, such as around 28 degrees Fahrenheit. A thermostat 564 can be placed within the beverage compartment 442. The thermostat 564 can be in electronic communication with the controller 560. The controller 560 can control the operation of the condenser 530 (turn the condenser ON/OFF) based on readings from the thermostat 564, which can be digital or analog.

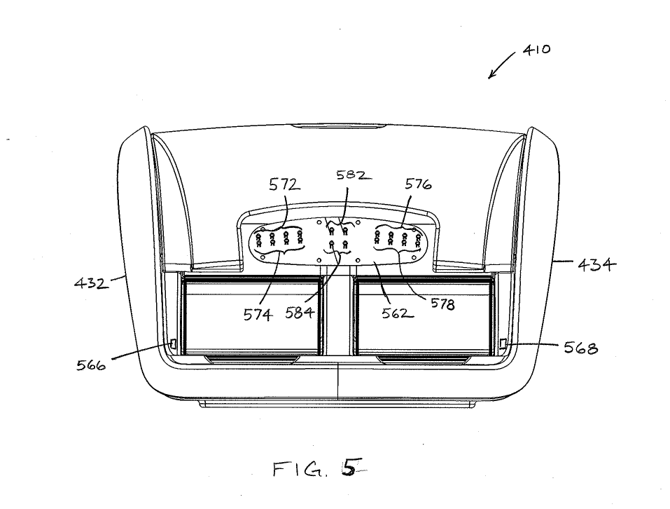

With reference to FIG. 5, an infrared (IR) temperature sensor 566, 568 can also be placed within the beverage dispensing unit 410. Each IR sensor 566 is disposed adjacent a respective dispensing outlet 416, 426. The display 522 on the housing 412 is in communication with each IR sensor 566. The display 522 is configured to present information based on the temperature sensed by the sensor 566. Each IR sensor 566, 568 detects the temperature of the beverage can adjacent the respective dispensing outlet 416, 426.

FIG. 5 depicts a plurality of LEDs mounted to the circuit board 562. A left upper set of LEDs 572 are disposed on a left side (per the orientation shown in FIG. 5) of the printed circuit board 562. A left lower set of LEDs 574 are disposed on the left side of the printed circuit board 562 below the left upper set of LEDs 572. A right upper set of LEDs 576 is disposed on the right side of the circuit board 562, and a right lower set of LEDs 578 is disposed beneath the right upper set of LEDs 576. Central upper LEDs 582 are also mounted to the circuit board 562 in between the left upper set of LEDs 572 and the right upper set of LEDs 576. Central lower LEDs 584 are disposed beneath the central upper LEDs 582. The central LEDs 582, 584 depict in which mode the cooling system is operating. The central upper LEDs 582 are disposed behind the first button 552 (FIG. 3) and the central lower LEDs 584 are disposed behind the second button 554 (FIG. 3). Pressing the first button 552 results in the central upper LEDs 582 illuminating and the central lower LEDs 584 do not illuminate. Pressing of the second button 554 results in the central lower LEDs 584 illuminating and the central upper LEDs 582 do not illuminate.

The left IR sensor 566 can control the operation of the left LEDs 572, 574. The right IR sensor 568 can control the illumination of the right LEDs 576, 578. The upper LEDs 572, 576, and 582 can all be the same color, e.g. white. The lower LEDs 574, 578, 584 can all be the same color, e.g. blue, which can be different from the color of the upper LEDs. An example of operation is described where a beverage can adjacent the left dispensing outlet 416 gradually cools. The number of LEDs that are illuminated on the left side of the printed circuit board 562 can increase. For example, when the beverage dispensing unit 410 is operating in a “super cool” mode, this is in response to the operator depressing the second button 554, the left IR sensor 566 measures the temperature of the beverage can adjacent the left dispensing outlet 416. Each of the LEDs in the left lower set of LEDs 574 can be illuminated when the beverage container adjacent the left dispensing outlet 416 is at or near the freezing point of the carbonated non-alcoholic beverage in the unopened container. When the beverage container adjacent the left dispensing outlet 416 is above this set temperature, fewer of the LEDs can be illuminated. The number of LEDs illuminated can be a function of the temperature of the beverage can being measured by the IR sensor 566. The thermostat 564 is different than the IR sensors 566 and 568. The thermostat 564 can be for controlling the cooling system, i.e. controlling the ON/OFF function of the compressor 530. The IR sensors 566, 568 can detect the temperature of the beverage cans and illuminate the LEDs 572, 574, 576, 578 appropriately, as described above.

With reference back to FIG. 3, the housing track member 448 includes a central divider 600. The central divider 600 can be generally vertically oriented and located approximately midway between the left side 432 and the right side 434 of the housing 412 when the housing track member 448 is disposed within the beverage compartment 442. The housing track member also includes a horizontal shelf: a left horizontal shelf 602 and a right horizontal shelf 604 are provided in the illustrated embodiment. The horizontal shelves define a surface along which beverage containers roll for a portion of each beverage container dispensing channel 418, 428.

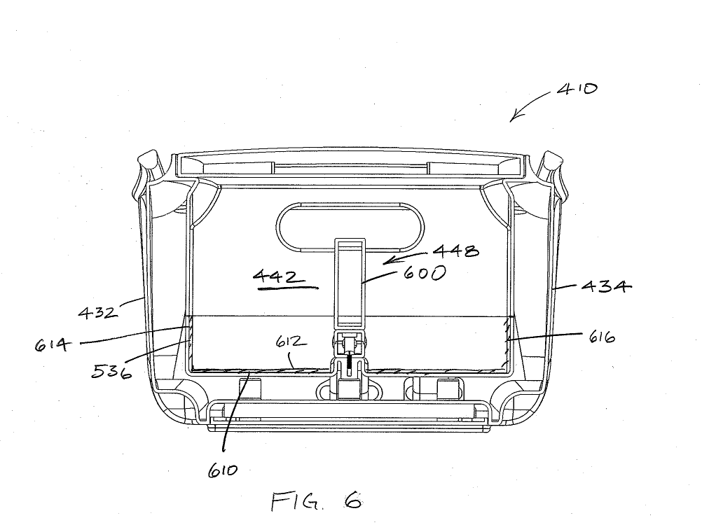

With reference to FIG. 6, the evaporator plate 536 can be generally U-shaped. The evaporator plate 536 includes a lower section 610 positioned along a lowermost surface 612 of each beverage container dispensing channel 418, 428. As such, the cooling system includes the evaporator plate 536, which is positioned along the lowermost surface 612 of each beverage container dispensing channel 414, 424. The beverage containers located within the beverage compartment 442 along the lower section 612 of each beverage container dispensing channel 418, 428 contact the evaporator plate 536 en route to the respective dispensing outlet 416, 426. As such, the beverage containers can come in direct contact with the evaporator plate 536 for efficient cooling. As mentioned above, the evaporate plate 536 is substantially U-shaped and includes the lower section 610, which is positioned along the lowermost surface 612 of each beverage container dispensing channel 418, 428. The evaporator plate is situated within the housing 412 to include side sections: a left side section 614 and a right side section 616. Each side section is disposed adjacent circular ends of the beverage containers positioned along the lowermost surface 612 of each beverage container dispensing channel 418, 428.

A beverage dispensing unit and a method for assembling a beverage dispensing unit has been described above with the detail. Modifications and alterations will occur to those upon reading and understanding the preceding detailed description. It is to be understood that the invention, which is defined by the appended claims, is not limited to only the embodiments described above. Instead, the invention is broadly defined by the appended claims and the equivalents thereof.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A beverage dispensing unit for dispensing associated beverage containers each containing a carbonated non-alcoholic beverage, the beverage dispensing unit comprising:
a housing including a beverage container inlet, a dispensing outlet and a beverage container dispensing channel defined in the housing between the beverage container inlet and the dispensing outlet;
a cooling system in the housing for cooling the associated beverage containers disposed along the beverage container dispensing channel;
a user input device on the housing for receiving user input to control the cooling system; and
a controller in communication with the user input device and the cooling system, wherein the controller is configured to operate the cooling system to maintain the beverage container dispensing channel within at least one of a first temperature range and a second temperature range based on input received from the user input device;
wherein the second temperature range is lower than the first temperature range and the second temperature range is below the freezing point of water and above a freezing point of a carbonated non-alcoholic beverage in an unopened container.

2. The beverage dispensing unit of claim 1, wherein the at least one beverage container dispensing channel has a maximum height that is less than three times a maximum diameter of one of the associated beverage containers and a maximum depth less than 3.5 times the maximum diameter of one of the associated beverage containers.

3. The beverage dispensing unit of claim 2, wherein the first temperature range is between about 36 degrees and about 42 degrees Fahrenheit.

4. The beverage dispensing unit of claim 1, wherein the cooling system includes an evaporator plate positioned along a lowermost surface of the beverage container dispensing channel, wherein associated beverage containers located along a lower section of the at least one beverage container dispensing channel contact the evaporator plate en route to the dispensing outlet.

5. The beverage dispensing unit of claim 4, wherein the evaporator plate is substantially U-shaped and includes a lower section positioned along the lowermost surface of the beverage container dispensing channel.

6. The beverage dispensing unit of claim 5, wherein the evaporator plate is situated to include side sections, each side section disposed adjacent circular ends of associated beverage containers positioned along the lowermost surface of the beverage container dispensing channel.

7. The beverage dispensing unit of claim 1, further comprising:
a sensor in the housing for sensing the temperature of the associated beverage container adjacent the beverage dispensing outlet; and
a display on the housing in communication with the sensor, wherein the display is configured to present information based on the temperature sensed by the sensor.

8. The beverage dispensing unit of claim 7, further comprising a thermostat, which is different than the sensor, for controlling the cooling system, wherein the thermostat measures the temperature of the at least one beverage container dispensing channel and is in communication with the control.

9. The beverage dispensing unit of claim 1, wherein the user input includes a first button and a second button, wherein the control is configured to operate the cooling system within the second temperature range based upon receiving an input from the second button.

10. The beverage dispensing unit of claim 1, further comprising:
an inlet door connected with the housing and selectively covering the beverage container inlet; and
an access door connected with the housing and selectively covering an area of the at least one beverage container dispensing channel downstream from the beverage container inlet.

11. The beverage dispensing unit of claim 10, wherein the inlet door pivots in a first rotational direction from a closed position toward an open position about an inlet door pivot axis, and the access door pivots in a second rotational direction, which is opposite to the first rotational direction, from a closed position toward an open position about an access door pivot axis, which is substantially parallel to the inlet door pivot axis.

12. The beverage dispensing unit of claim 11, further comprising a housing track member defining a portion of the at least one beverage container dispensing channel, wherein the housing track member is removable from the housing without the use of tools when the inlet door and the access door are each in the open position.

13. The beverage dispensing unit of claim 10, wherein the at least one beverage container dispensing channel includes a first beverage container dispensing channel and a second beverage container dispensing channel, wherein both the first and the second beverage container dispensing channel are accessible when at least one of the inlet door and the access door are in the open position.

14. A beverage dispensing unit for dispensing associated beverage containers, the beverage dispensing unit comprising:
a housing including a beverage compartment and a cooling system components compartment;
a compressor disposed in the cooling system components compartment;
a condenser plate in fluid communication with the compressor; and
an evaporator plate in fluid communication with the compressor and positioned along a lowermost surface of the beverage compartment such that associated beverage containers positioned within the beverage compartment contact the evaporator plate.

15. The beverage dispensing unit of claim 14, wherein the evaporator plate is positioned such that the associated beverage containers located along a lower section of the beverage compartment contact the evaporator plate en route to a dispensing outlet of the beverage dispensing unit.

16. The beverage dispensing unit of claim 15, wherein the evaporator plate is substantially U-shaped and includes a lower section positioned along the lowermost surface of the beverage compartment.

17. The beverage dispensing unit of claim 14, wherein the beverage compartment has a maximum height of less than about 7.5 inches, a maximum depth of less than about 8.75 inches and a maximum width of less than about 9.5 inches.

18. The beverage dispensing unit of claim 14, further comprising:
a user input device on the housing for receiving user input to control the compressor; and
a controller in communication with the user input device and the compressor, wherein the controller is configured to operate the compressor to maintain the beverage compartment within at least one of a first temperature range and a second temperature range based on input received from the user input device;
wherein the second temperature range is lower than the first temperature range and the second temperature range is below the freezing point of water and above a freezing point of a carbonated non-alcoholic beverage in an unopened container.

19. The beverage dispensing unit of claim 18, wherein the first temperature range is between about 36 degrees and about 42 degrees Fahrenheit.

20. The beverage dispensing unit of claim 14, wherein the evaporator plate is U-shaped.
